(19) United States
(12) Patent Application Publication
(10) Pub. No.: US 2020/0177042 A1
(43) Pub. Date: Jun. 4, 2020

(54) SHAPED STATOR WINDINGS FOR A SWITCHED RELUCTANCE MACHINE AND METHOD OF MAKING THE SAME

(71) Applicant: Software Motor Company, Sunnyvale, CA (US)

(72) Inventors: Piyush Desai, Des Plaines, IL (US); Edgar Hu, Taipei (TW); Mark Johnston, Los Altos Hills, CA (US)

(21) Appl. No.: 16/601,242

(22) Filed: Oct. 14, 2019

Related U.S. Application Data
(60) Provisional application No. 62/744,707, filed on Oct. 12, 2018.

(51) Int. Cl. H02K 3/18; H02K 1/14; H02K 15/04; H02K 15/06

(52) U.S. Cl. CPC H02K 3/18; H02K 15/065; H02K 15/045; H02K 1/145

(57) ABSTRACT

The present invention is a method for producing a plurality of curved stator windings by shaping a plurality of stator coils for a switched reluctance machine (SRM). The present invention proposes apparatus and methods for utilizing a plurality of curved stator windings with two main embodiments: a symmetrical winding and an asymmetrical winding, whereby the plurality of curved stator windings are highly conforming to a curved stator shape. The plurality of curved stator windings provides higher efficiency and lower noise to the SRM. The plurality of curved stator windings conforms to the stator curved shape, maximizing the copper fill factor, thereby permitting maximum copper utilization in the machine.

### PRIORITY

This application claims priority from the United States provisional application with Ser. No. 62/744,707 and filed Oct. 12, 2018. The disclosure of that provisional application is incorporated herein as if set out in full.

### DESCRIPTION OF THE RELATED ART

### Technical Field of the Disclosure

This invention relates in general to stator windings for switched reluctance machines. More particularly, this invention relates to shaped windings that are highly conforming to the stator shape and stator pole shape of a switched reluctance machine.

### Background of the Disclosure

A switched reluctance machine (SRM) is a doubly salient machine, that is, it comprises multiple poles on both stator and rotor. The SRM may have a plurality of stator poles, each with multiple loops of electrically conductive wires or in total a coil or winding positioned thereabout. The stator poles of the SRM are integral parts of the stator. The stator windings comprising each machine phase winding are connected in series or in parallel, so that when a phase winding is excited, magnetic flux produced in the corresponding pair(s) of stator poles combines additively. The phases of the stator are energized sequentially in a cyclical fashion so that a magnetic force of attraction occurs between the energized stator pole and the rotating rotor, thereby causing the rotor to rotate. As is well known in the art, this current must be switched on and off at proper times at proper rotor position to provide the attraction between rotor poles and the energized stator pole without producing a negative or braking attraction once the rotor reaches its aligned position with the stator.

Normally, in a conventional SRM, each of the stators and the rotors has a salient structure. The stator has a winding wound on salient parts thereof to generate a reluctance torque according to variations in magnetic reluctance, while the rotor has no magnetization mechanism such as a coil or a permanent magnet. The rotor is connected at a central part thereof, to and rotated together with, a rotational axis that transmits a driving force of the machine. The SRM is an electric machine that converts the reluctance torque into mechanical power. The torque is produced by the alignment tendency of poles. The rotor will shift to a position where reluctance of the magnetic circuit is minimized and the inductance of the energized winding of the stator is maximized. The SRM rotates the rotor by using the reluctance torque generated according to variations in magnetic reluctance.

One conventional SRM disclosed in U.S. Pat. No. 8,541,920 comprises a conventional SRM with a stator having plurality of poles, each of which has its concentric windings connected in a manner that achieves a required number of machine phases. The conventional SRM further comprises a rotor having a plurality of poles with neither windings nor magnets on the rotor poles. The windings in this disclosure are of either an L shape or a triangular shape, with each one representing the part of the coil on one side of the pole winding. Because they each constitute a coil side of the pole winding, the pole windings will have two of them side by side for placement on the stator poles, with interconnection for each of the individual conductors and that populate the coil sides. The space volume between the stator poles is filled with a maximum number of winding turns so as to have maximum number of turns per phase winding in the SRM. The shapes and forms are simple to realize in practice and manufacture through automation. However, this conventional approach fails to produce curved stator windings conforming to the stator curved shape. Also, this approach fails to fully utilize the potential copper fill factor.

Another conventional approach describes a rotary electric machine, the rotary electric machine includes a stator having an open slot configuration and a plurality of stator poles with a coil positioned about each stator pole. As described in U.S. Pat. No. 9,118,225 to Caterpillar Inc., the coil has a plurality of electrically conductive wires defining a group of wires and the group of wires is wrapped generally around a stator pole to define a plurality of turns. The coil may be formed with a generally symmetrical cross-section and the lateral movement of at least some of the electrically conductive wires of each turn while mounting the coil on the stator pole may modify the shape of the coil to form a generally asymmetrical cross-section across a portion thereof. The asymmetrical cross-section may extend across a portion of a pair of adjacent stator slots that are separated by a stator pole. This assembly of the machine is complicated. Further, this conventional approach does not teach shaping of the windings and does not facilitate formation of stator shape-conforming windings for SRMs.

Another approach is disclosed in US Patent Publication 2005/0258702, wherein disclosed is a stator comprising a plurality of stator teeth, a first set of windings and a second set of windings. The first set of windings are wound around some of the stator teeth that define a first cross section, the first cross section including an approximately equal number of turns along the stator tooth and is generally rectangular-shaped. The second set of windings is formed around others of the stator teeth that each defines a second cross section, the second cross section includes an increasing number of turns along the stator tooth and is generally trapezoidal-shaped. The first and second sets of windings are interleaved around the teeth of the stator. This multiple shape windings method improves the torque density of the electric machine. However, this approach does not follow a two-step process to achieve the shaping of the windings. Furthermore, this approach fails to produce curved stator windings conforming to the stator curved shape.

Therefore, there is a need for shaping of stator windings to increase the copper fill factor for SRMs. The associated method of shaping the stator windings would produce curved stator windings, the curved stator windings being highly conforming to the stator shape. This needed method of shaping of windings would include two main embodiments—symmetrical shaping and asymmetrical shaping. Further, such curved stator windings conforming to the stator curved shape would allow more copper in the SRM. A design using this method of shaping stator windings would allow the motor to provide more torque, more speed, higher power density, lower noise, and/or many other smart tradeoffs for overall better performance. Such a system would be highly efficient and reliable. The present embodiment overcomes shortcomings in this area by accomplishing these critical objectives.

### SUMMARY OF THE DISCLOSURE

To minimize the limitations found in the prior art, and to minimize other limitations that will be apparent upon the reading of the specification, the present invention is a process for shaping a plurality of stator windings for a switched reluctance machine (SRM). The present invention proposes an apparatus and method for making an apparatus utilizing a plurality of curved stator windings, the invention comprising two main embodiments: a symmetrical winding and an asymmetrical winding. In either case, the plurality of stator poles is highly conforming to a stator shape. The plurality of curved stator windings further provides an additional degree of freedom, such that a motor using this method allows more torque, more speed, higher power density, lower noise, and/or many others smart tradeoffs for overall better performance, such as, higher efficiency, lower noise, higher torque and lower temperature rise to the machine. The plurality of curved stator windings conforms to the stator curved shape, increasing the copper fill factor, which in turn allows maximum copper in the machine, ultimately resulting in increased efficiency and reduced noise in the machine. The increase in the copper fill factor can be utilized in different ways, including but not limited to increasing the number of turns, using thicker magnetic wire and a combination of a greater number of turns with thicker magnetic wire.

The method for producing the plurality of curved stator windings by shaping the plurality of stator windings for the SRM is initiated by winding a first stator coil with a magnetic wire on a tooling implement such as but not limited to a mandrel, mold or fixture. Heating the first stator coil in a straight form is a next step, followed by removing the first stator coil from the tooling, resulting in a simple winding coil. In the preferred embodiment, the next step is assembling the simple winding coil into a cylindrical form tooling. Then, heating the simple winding coil and pressing the simple winding coil into the curved stator winding shape. Finally, optionally providing insulation to the curved stator windings by utilizing a plurality of insulation means. Thus, the plurality of curved stator windings is produced by shaping the plurality of stator coils in the SRM. Of note, the herein described heating steps are flexible in terms of their ordering. The heating steps may also be removed from the method completely.

It is a first objective of the present invention to provide a method for producing a plurality of curved stator windings by shaping a plurality of stator windings for an SRM.

A second objective of the present invention is to provide a method for shaping of windings to increase the copper fill factor for an SRM.

A third objective of the present invention is to produce curved stator windings which are conformed to a stator shape.

A fourth objective of the present invention is to produce curved stator windings which enable higher efficiency and lower noise in an SRM.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of the various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

The foregoing aspects and many of the attendant advantages of the invention will become more readily appreciated as the same becomes better understood by reference to the following detailed description, when taken in conjunction with the attached figures.

FIG. 1A and FIG. 1B are cross-sectional views of a switched reluctance machine having a stator that includes a plurality of symmetrical curved stator windings and a plurality of stator poles according to the preferred embodiment of the present invention;

FIG. 2 is one embodiment of the preferred embodiment of the present invention including symmetric curved stator windings;

FIGS. 3A, 3B, 3C and 3D show additional embodiments of the present invention including asymmetric and interlocking curved stator windings;

FIG. 4 is a flowchart of a method for producing a plurality of curved stator windings of the preferred embodiment of the present invention;

FIG. 5A is an alternative embodiment of a switched reluctance machine with symmetrical curved stator windings according the present invention shown in front view;

FIG. 5B is the alternative embodiment of the present invention shown in a first cutaway cross sectional view;

FIG. 5C is the alternative embodiment of the present invention shown in a second cutaway cross sectional view;

FIGS. 6A and 6B show additional embodiments of the present invention including the drive end front view (FIB. 6A) and the non-drive end rear view (FIG. 6B) for symmetrical curved stator windings; and

FIG. 7A is one embodiment of the present invention shown in cross-sectional view, side view (FIG. 7B) and plan view (FIG. 7C).

### DETAILED DESCRIPTION OF THE PREFERRED EMBODIMENT

In the following discussion that addresses a number of embodiments and applications of the present invention, reference is made to the accompanying drawings that form a part hereof, and in which is shown by way of illustrating specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. In the following discussion that addresses a number of embodiments and applications of the present invention, reference is made to the accompanying drawings that form a part hereof, and in which is shown by way of illustrating specific embodiments in which the invention may be practiced. It is to be understood that other embodiments may be utilized, and changes may be made without departing from the scope of the present invention.

The shaping process contemplated by the present invention produces curved stator windings 104, the curved stator windings 104 being highly conformed to the stator shape in all embodiments. This method of shaping comprises two main embodiments including symmetrical shaping and asymmetrical shaping. The primary difference between these two embodiments is the shape of the final product.

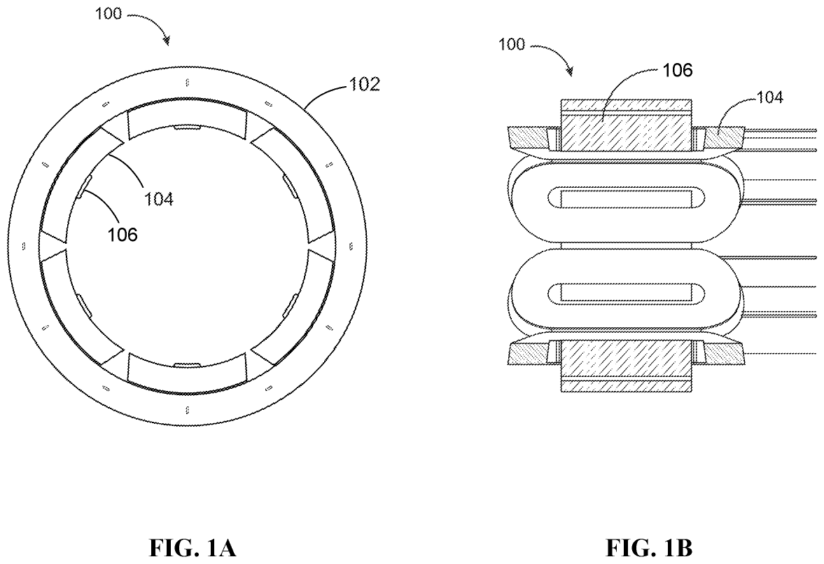

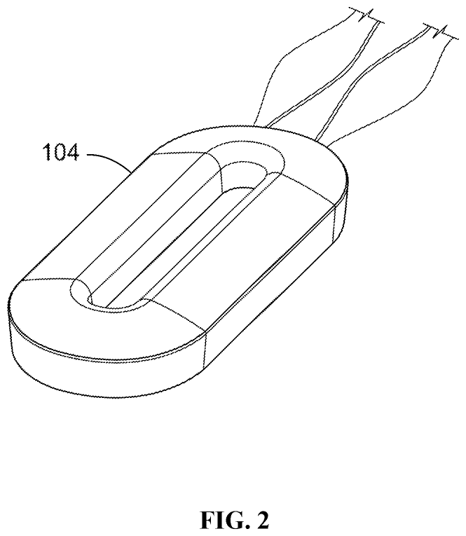

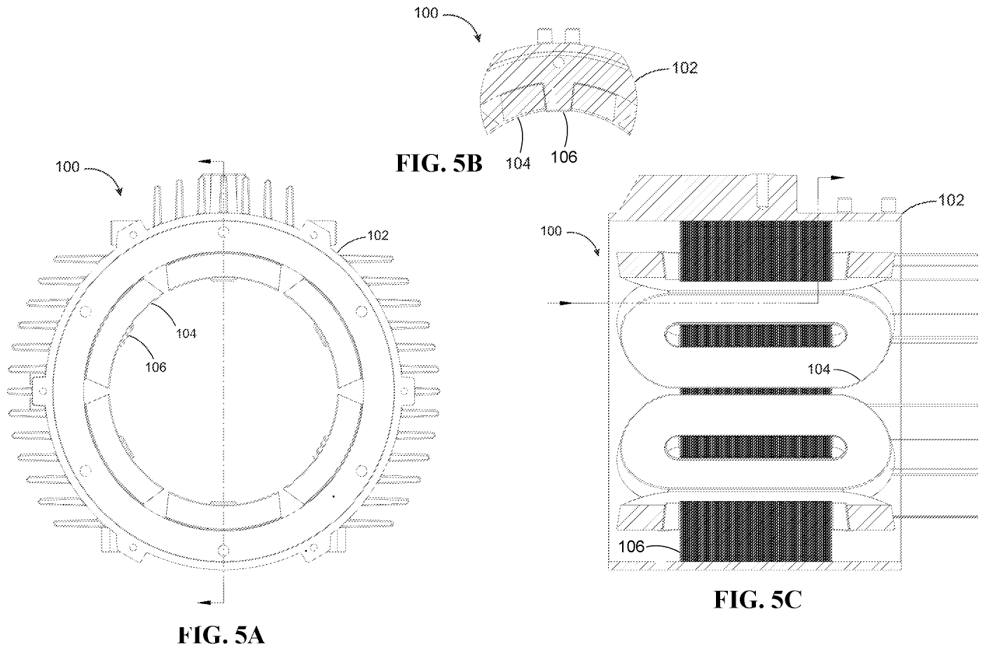

FIG. 1A and FIG. 1B are cross-sectional views of the above-described final product. In the preferred embodiment, the final product comprises a switched reluctance machine (SRM) 100 having a stator 102 that includes a plurality of symmetrical curved stator windings 104 and a plurality of stator poles 106. Notably, the curved stator windings 104 in the symmetrical embodiment are identical in shape and are interchangeable with any of the other windings in a given SRM machine. In addition, in the preferred embodiment of the symmetrical curved winding, the distance between every winding, or coil, and the winding adjacent to it is 1-2 mm. As compared to conventional coils, the shape that is filled with copper is greater in these curved stator windings 104 due to the symmetrical shaping of the coil. The characteristic of symmetrical shape is shown in FIG. 1A, exemplified by the triangular gap present between the curved stator windings 104. Further to the above, in the preferred symmetrical shaping embodiment there are at least 6 identical coils as shown in FIG. 1A. FIGS. 5A-5C provide additional views of an SRM machine with symmetrical curved stator windings and a plurality of stator poles, including a cross-sectional and interior view of the windings according to one embodiment of the present invention.

Further to the above, as shown in FIG. 1A and FIG. 2, in some embodiments symmetric shaping may involve at least one electrically conductive material conformed to the curved stator windings 104 and stator poles 106. Viewed from a cross-section of the switched reluctance motor showing the curved stator windings 104 and stator poles 106 (FIG. 1A), the windings have a substantially smooth exterior geometric arc and a substantially smooth interior geometric arc of a smaller radius than said exterior geometric arc, with a plurality of triangular gaps present between curved stator windings 104 in the symmetric shaping model.

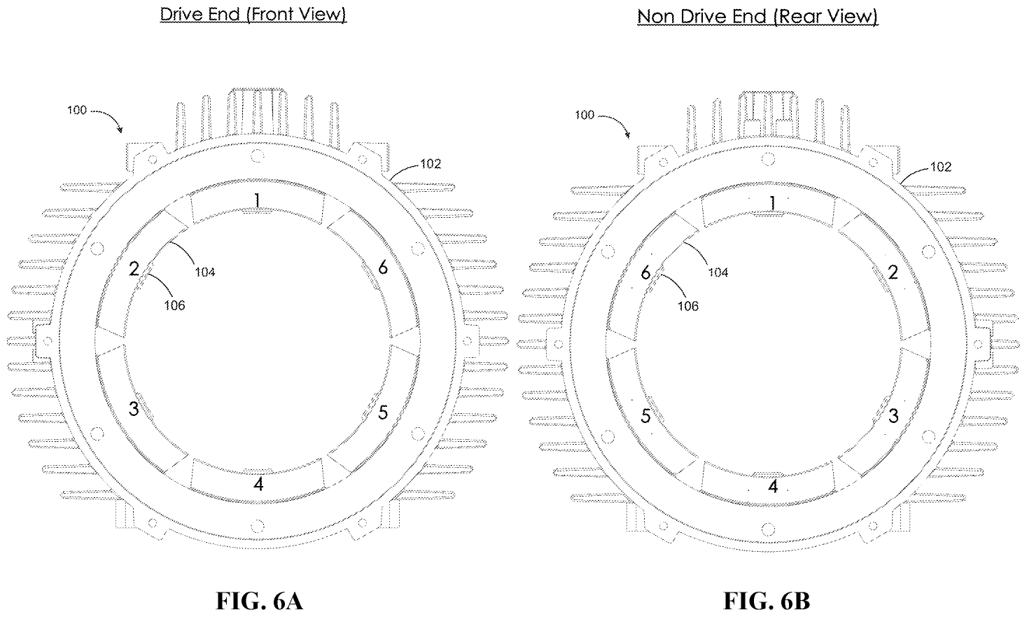

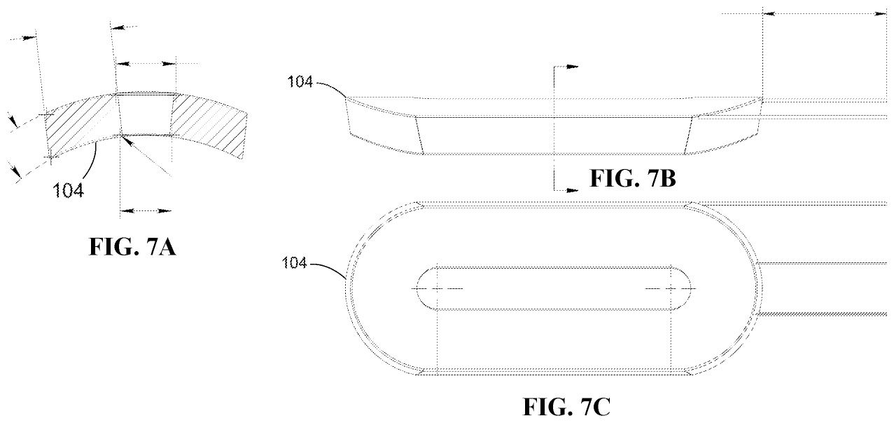

FIG. 6A & FIG. 6B depict an additional view of an SRM machine with symmetrical curved stator windings including a drive end front view (FIB. 6A) and non-drive end rear view (FIG. 6B). Both the drive end front view and rear view in FIG. 6A and FIG. 6B show six substantially identical, sequentially numbered stator windings. FIG. 7A-7C illustrate yet another embodiment of the present invention including symmetrical curved stator windings and a cross-sectional view of the coil dimensions. As noted above, in some embodiments of the present invention with symmetrical curved windings, the distance between every coil and the coil adjacent to it is about 1-2 mm. In other embodiments the distance is no less than 1 mm and no more than 2 mm. In still other embodiments the distance is no less than 1 mm and in still further embodiments the distance is about 1 mm.

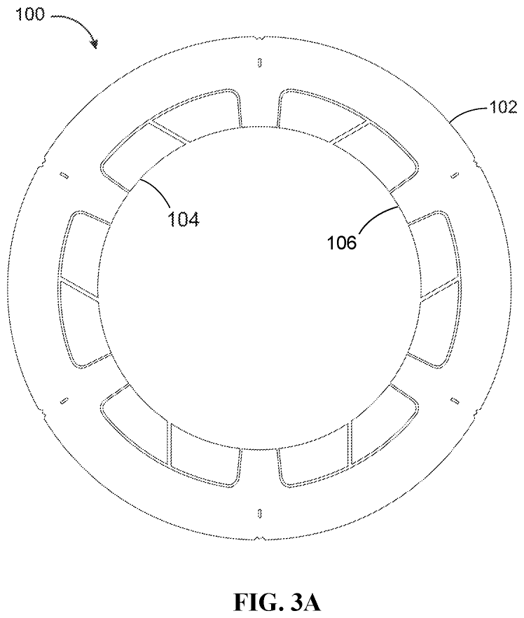

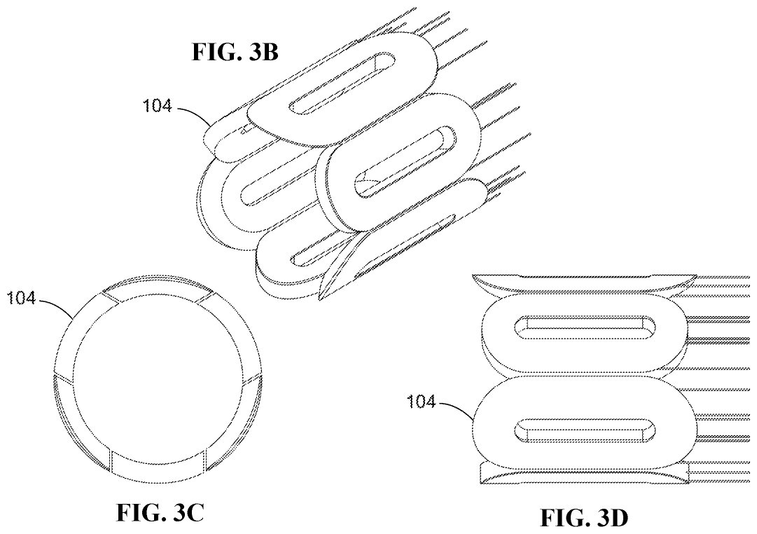

As shown in FIG. 3A, in the preferred asymmetrical shaping embodiment, adjacent coils are non-identical and form interlocking segments. In general, the intent of the asymmetrical model is to maintain a consistent and minimized distance between the windings (or “coils”) in order to enhance the structural and functional characteristics of the SRM machine. FIG. 3A illustrates an asymmetric model including three curved odd shaped stator windings 104 and three curved even shaped stator windings 104. As shown in FIG. 3A, odd shaped coils and even shaped coils are arranged adjacent to each other and form interlocking segments. In one embodiment, coils 1, 3, and 5 are odd shaped and are identical to one another while coils 2, 4, and 6 are even shaped and are identical to one another. In the preferred embodiment, no part of the boundary of any winding or the asymmetric model is greater than 1 mm away from any part of an adjacent edge of an adjacent coil. In another embodiment, said distance is no greater than 2 mm. Notably, despite the fact that the shape of each asymmetrical winding may not be identical in a given SRM machine, the surface area and volume of each asymmetrical winding is substantially identical in the preferred embodiment of the invention.

FIG. 3A-3D illustrate an asymmetric winding of the stator configuration in accordance with another embodiment of the present invention. Arguably, the asymmetric winding provides the greatest benefit in terms of copper fill factor. However, this pattern of winding may lead to an increased complexity of assembly because it requires two types of shapes, such as stator windings 1, 3, 5 and stator windings 2, 4, 6. FIGS. 3B-3D illustrate a nesting assembly for the asymmetric curved stator windings 104. In one example, an asymmetric curved stator winding 104 may comprise three odd shaped curved stator windings 1, 3 and 5 and three even shaped curved stator windings 2, 4 and 6. Each of curved stator windings 1, 3 and 5 are placed with an interlocking fit between odd shaped curved stator windings 2, 4 and 6. In the above examples, odd shaped curved stator windings are identical to each other, and even shaped curved stator windings are identical to each other.

Further to the above, as shown in FIG. 3A and FIG. 2, in some embodiments symmetric shaping may involve at least one electrically conductive material conformed to the curved stator windings 104 and stator poles 106. Viewed from a cross-section of the switched reluctance motor showing the curved stator windings 104 and stator poles 106 (FIG. 1A), the windings have a substantially smooth exterior geometric arc and a substantially smooth interior geometric arc of a smaller radius than said exterior geometric arc, the windings further comprising at least one even shaped curved stator windings having an interlocking fit with at least one odd shaped curved stator winding as described above.

As described above, in the preferred embodiment every symmetrical winding may be substantially identical in shape. In another embodiment, symmetrical windings are substantially identical in volume and surface area as well. As a result, every stator winding in a symmetrical system may be interchangeable with any of the other windings in that SRM. In the preferred embodiment of the asymmetric model on the other hand, the windings are non-identical in shape, although they may continue to maintain substantially the same surface area and volume as the other asymmetric windings in a given SRM. Notably, in the preferred embodiment of the asymmetric model, no winding is greater than 1 mm in distance from an adjacent winding. In a less preferred embodiment, no winding is greater than 2 mm in distance from an adjacent winding.

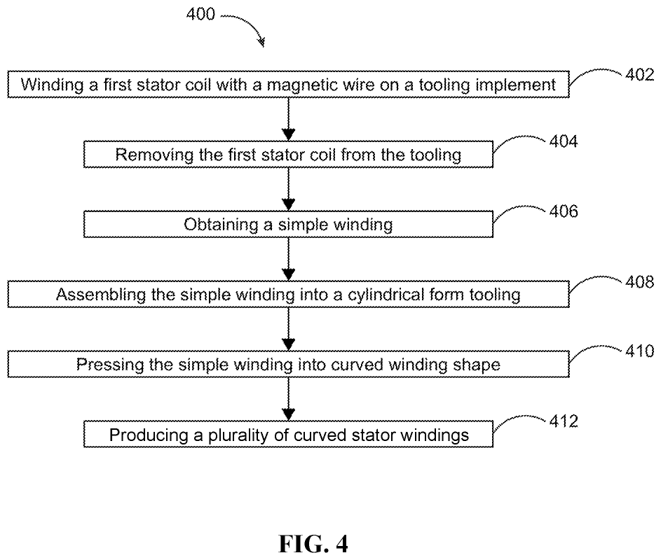

FIG. 4 is a flowchart depicting a method for producing a plurality of curved stator windings 104 of the preferred embodiment of the present invention. The method for producing the plurality of curved stator windings by shaping the plurality of stator coils for the switched reluctance machine 400 is initiated by winding a first stator coil with a magnetic wire on a tooling implement such as but not limited to a mandrel, mold or fixture as shown in the block 402. Optionally, one may heat the first stator coil into a straight form as the next step. Next, one removes the first stator coil from the tooling as shown in the block 404 to obtain a simple winding as shown in block 406. Next, one assembles the simple winding into a cylindrical form tooling as shown in the block 408. Optionally, as a final step one may heat the simple winding and press the simple winding into the curved stator winding shape of a curved stator winding 104 as shown in the block 410. Thus, the plurality of curved stator windings 104 are produced by shaping a plurality of stator coils in the SRM as shown in the block 412. In an alternative optional embodiment, the curved stator windings 104 may utilize a plurality of insulation means, which may be added to the windings as an optional step of the process.

As described above, the present invention is a process for shaping a plurality of stator coils for an SRM. Notably, the present invention also proposes an apparatus, utilizing a plurality of curved stator windings 104 and has two main embodiments: a symmetrical winding and an asymmetrical winding. The plurality of curved stator windings 104 are highly conformed to a stator shape. The plurality of curved stator windings 104 provide serval performance enhancements including higher efficiencies and lower noise output to the SRM. The plurality of curved stator windings 104 also provide one more degree of freedom, such that a motor using this method allows more torque, more speed, higher power density, lower noise, and/or many others beneficial tradeoffs resulting in an overall enhanced performance. Such enhanced performance further comprises a greater output efficiency, increased torque and lower temperature rise to the machine. As described above, the plurality of curved windings 104 also closely conform to the stator curved shape, increases the copper fill factor, which in turn allows maximum copper utilization in the machine. Maximum copper utilization translates to reduced noise, a greater number of winding turns, and/or an electrically conductive material with a thickness greater than the industry standard along the length of the electrically conductive material. The plurality of curved stator windings 104 may also be insulated to a higher degree relative to the industry standard in some embodiments.

As described herein, the method permits use of an electrically conductive material such as a magnetic wire, or any highly conductive metal, with a thickness greater than the industry standard along the length of the electrically conductive material. The magnet wire may be simple or a bondable magnetic wire. Further, the magnetic wire may be made of aluminum or any comparable metallic wire. In the case of bondable magnetic wire, the bondable magnetic wire may be activated by any means, such as alcohol, suitable chemicals, heat, or resistive heating by applying the voltage/current to the magnet wire. The wire may be at room temperature or heated during any step of the process. Furthermore, the molds used for winding or shaping may be at room temperature or heated and this could be done at any step in the process.

The claimed subject matter has been provided here with reference to one or more features or embodiments. Those skilled in the art will recognize and appreciate that, despite the detailed nature of the exemplary embodiments provided here; changes and modifications may be applied to said embodiments without limiting or departing from the generally intended scope. These and various other adaptations and combinations of the embodiments provided here are within the scope of the disclosed subject matter as defined by the claims and their full set of equivalents.

The foregoing description of the preferred embodiment of the present invention has been presented for the purpose of illustration and description. It is not intended to be exhaustive or to limit the invention to the precise form disclosed. Many modifications and variations are possible in the shaping of the stator coils of the SRM of the above teachings. It is intended that the scope of the present invention not be limited by this detailed description, but by the claims and the equivalents to the claims appended hereto.

What is claimed is:

1. A stator of a switched reluctance machine, comprising:
a. a plurality of stator poles, each of the plurality of stator poles being associated with at least one of a plurality of curved stator windings, the plurality of curved stator windings exhibiting a symmetrical shaping wherein a plurality of loops comprising electrically conductive material and making up each curved stator winding follows a shaped pattern, such that the curved stator windings are substantially identical with one another; and
b. whereby the plurality of curved stator windings increases copper fill factor, which in turn is utilized for performance enhancements as compared to conventional switched reluctance machines and conventional windings.

2. The stator of the switched reluctance machine of claim 1 wherein for each of the windings, as viewed from a cross-section of the switched reluctance machine showing the curved stator windings and stator poles, the windings having a substantially smooth exterior geometric arc and a substantially smooth interior geometric arc of a smaller radius than said exterior geometric arc.

3. The stator of the switched reluctance machine of claim 2 wherein the switched reluctance machine when viewed from a cross-section comprises at least one substantially triangular gap disposed between curved stator windings.

4. The stator of the switched reluctance machine of claim 2, wherein the distance between every winding and the winding adjacent to it is between 1-2 mm at its closest point.

5. The stator of the switched reluctance machine of claim 1, wherein the plurality of curved stator windings are insulated.

6. A stator of a switched reluctance machine, comprising:
a. a plurality of stator poles, each of the plurality of stator poles being associated with at least one of a plurality of curved stator windings, the plurality of curved stator windings exhibiting an asymmetrical shaping wherein a plurality of loops comprising electrically conductive material and making up each curved stator winding follows a shaped pattern, such that a plurality of odd shaped curved stator windings are identical to each other and a plurality of even shaped curved stator windings are identical to each other; and
b. whereby the plurality of curved windings increases copper fill factor, which in turn is utilized for performance enhancements as compared to conventional switched reluctance machines and conventional windings.

7. The stator of the switched reluctance machine of claim 6, wherein:
a. for each of the windings, as viewed from a cross-section of the switched reluctance machine showing the curved stator windings and stator poles, the windings having a substantially smooth exterior geometric arc and a substantially smooth interior geometric arc of a smaller radius than said exterior geometric arc;
b. wherein the switched reluctance machine comprises at least one even shaped curved stator winding with a substantially consistent gap from at least one odd shaped curved stator winding; and
c. wherein said at least on even shaped curved stator winding is complementary in shape to said at least one odd shaped curved stator winding.

8. The stator of the switched reluctance machine of claim 7, wherein a surface area and volume of each winding is substantially identical to one another.

9. The stator of the switched reluctance machine of claim 7, wherein each winding has a side adjacent another winding, and a space between said sides is never greater than 4 mm in distance.

10. The stator of the switched reluctance machine of claim 7, wherein each winding has a side adjacent another winding, and a space between said sides is never greater than 2 mm in distance.

11. The stator of the switched reluctance machine of claim 7, wherein each winding has a side adjacent another winding, and a space between said sides is approximately 4 mm in distance.

12. The stator of the switched reluctance machine of claim 7, wherein each winding has a side adjacent another winding, and a space between said sides is approximately 2 mm in distance.

13. The stator of the switched reluctance machine of claim 7, wherein the plurality of curved stator windings are insulated.

14. A method for producing a plurality of curved stator windings for a switched reluctance machine, the method comprising the steps of:
a. winding a first stator coil with a conductive material on a tooling implement to form a plurality of loops;
b. removing the first stator coil from the tooling implement;
c. obtaining a simple winding;
d. placing the simple winding into a cylindrical form tooling; and
e. pressing the simple winding into the curved winding shape to create a curved stator winding;
f. repeating steps a-e a plurality of times to create a plurality of curved stator windings;
g. assembling the curved windings onto a switched reluctance machine stator such that a surface area and volume of each winding is substantially identical to one another.

15. The method for producing the plurality of curved stator windings according to claim 14 further comprising a step of taping.

16. The method for producing the plurality of curved stator windings according to claim 14 further comprising a step of varnishing.

17. The method for producing the plurality of curved stator windings according to claim 14, wherein the conductive material is a bondable magnetic wire.

18. The method for producing the plurality of stator windings according to claim 17 wherein the bondable magnetic wire is activated by at least one of heat, voltage, current, and/or chemical activation.

19. The method for producing the plurality of stator windings according to claim 17 wherein the bondable magnetic wire is activated chemically by alcohol.

20. The method for producing the plurality of stator windings according to claim 17 wherein the bondable magnetic wire is activated by resistive heating.
